(19) United States
(12) Patent Application Publication
(10) Pub. No.: US 2019/0325098 A1
(43) Pub. Date: Oct. 24, 2019

(54) SYSTEM, METHOD, AND COMPUTER PROGRAM FOR PART MODEL GENERATION AND ANALYSIS AND PART PRODUCTION AND VALIDATION

(71) Applicant: Honeywell Federal Manufacturing & Technologies, LLC, Kansas City, MO (US)

(72) Inventor: Gregory John Vernon, Kansas City, MO (US)

(73) Assignee: Honeywell Federal Manufacturing & Technologies, LLC, Kansas City, MO (US)

(21) Appl. No.: 15/959,910

(22) Filed: Apr. 23, 2018

(51) Int. Cl. G06F 17/50

(52) U.S. Cl. CPC G06F 17/5018; G06F 2217/16; G06F 2217/12

(57) ABSTRACT

A method for improving the production of an object via an additive manufacturing machine includes receiving a computer-aided design (CAD) part model, subdividing the part model into mesh elements so as to form a mesh, performing finite element analysis (FEA) on the mesh, and generating slice files based on the mesh for use in additive manufacturing, wherein the part model, mesh, and slice files have an isogeometric or isoparametric definition such that volumetric information is retained with the part model, mesh, and slice files.

### BACKGROUND

Computer aided design (CAD), finite element analysis (FEA), additive manufacturing, and part validation are typically performed within different computer model frameworks, which requires users to reconfigure part models or convert them between data formats such as stereolithography format (STL), polygon format (PLY), additive manufacturing format (AMF), and three dimensional manufacturing format (3MF). Unfortunately, this is time consuming and often introduces user and computer-based errors and inconsistencies. Cross-format model validation and part validation for complex parts is virtually impossible due to the large amount of data involved, which prevents errors and inconsistencies from being resolved and often results in manufactured parts that have structural or functional flaws or do not conform to the original design intent.

Furthermore, current data formats developed for additive manufacturing have significant limitations. For example, additive manufacturing slice files are often prepared using only surface definitions of the part, which does not allow for the inclusion of volumetrically varying information such as graded materials. Other advancements in additive manufacturing such as united cellular lattice structures are restricted by current additive manufacturing data formats.

### SUMMARY

Embodiments of the present invention solve the above-described and other problems and limitations by providing improved computer modeling and additive manufacturing systems and processes. More particularly, the invention provides a computer modeling and additive manufacturing system and method in which volumetric information, metadata, and other information is retained throughout part model generation and analysis and part production and validation within an isogeometric or isoparametric definition.

An embodiment of the invention is a method of generating and analyzing a computer model of a part, forming the part via additive manufacturing according to the computer model, and validating the part. First, the part model is received or generated in a CAD tool. The part model may have an isogeometric or isoparametric definition and includes volumetric information, metadata, and/or other data required for additive manufacturing, conventional (e.g., subtractive) manufacturing, and/or hybrid manufacturing processes. For example, the volumetric information may include materials graded based on chemical composition, processing parameters, or any other suitable graded material characteristic.

The part model is then opened in an FEA tool or any other suitable meshing tool and subdivided into a plurality of finite elements so as to form a mesh of the part model. The isogeometric or isoparametric definition and the volumetric information, metadata, and other data is kept with the mesh such that representations of features of the part do not change.

FEA is then performed on the mesh via the volumetric information, metadata, and/or other data within the isogeometric or isoparametric definition. FEA may include structural, thermal, fluid flow, and electromagnetic analysis. Topology, shape, and/or size optimization is also performed on the mesh via the volumetric information, metadata, and/or other data within the isogeometric or isoparametric definition.

The part model and/or mesh may then be modified based on results of the FEA and the topology, shape, and/or size optimization. For example, some of the mesh elements may be removed and other mesh elements may be reshaped to increase a strength to weight ratio, improve heat dissipation, or change an electromagnetic signature or other characteristics of the part. FEA and optimization may be repeated until suitable part characteristics are achieved.

The part model or mesh is then divided into slice files via the volumetric information, metadata, and other data within the isogeometric or isoparametric definition. The part is then printed layer-by-layer via a 3D printer according to the slice files.

The part is then validated via volumetric analysis and/or surface measurements. For example, voxel data from a 3D scan of the part may be compared directly against the volumetric information of the part model or mesh. Actual material grading of the part may be compared directly against isogeometric or isoparametric-defined material grading information. Surface measurements may be compared directly against isogeometric or isoparametric-defined surface data.

Importantly, a single CAD representation of the part is used throughout CAD design, simulation, manufacturing, and validation. Specifically, volumetric information, metadata, and other data associated with the part model are kept with the part model and/or mesh and retain an isogeometric or isoparametric definition. In this way, the part model and/or mesh can be generated, analyzed, and optimized and the associated parts can be manufactured and validated directly from the part model or mesh without reconfiguring the part model or converting the part model to a different data format. This is particularly useful for incorporating material grading into the part and validating the material grading. The volumetric information may also include lattice location and deformation information for united cellular lattice structures as described in U.S. Patent Application Publication Number 2017-0203516 (hereinafter the “'516 publication”), hereby incorporated by reference herein in its entirety.

The user time and effort and computer cycles required to reconfigure the part model or convert the part model into different data formats are eliminated, which promotes late stage part improvement and modification. Importantly, user and computer-based errors and inconsistencies associated with switching between data formats are also eliminated, resulting in more accurate and efficient part model analysis and part production.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a block diagram of an embodiment of a system for improving the production of an object via an additive manufacturing machine;

FIG. 2 is a block diagram of four process modules across which embodiments of the invention may be performed; and

FIG. 3 is a flow diagram of a method of generating and analyzing a part model and producing and validating a part based on the part model.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular configurations of the present invention can include a variety of combinations and/or integrations of the embodiments described herein.

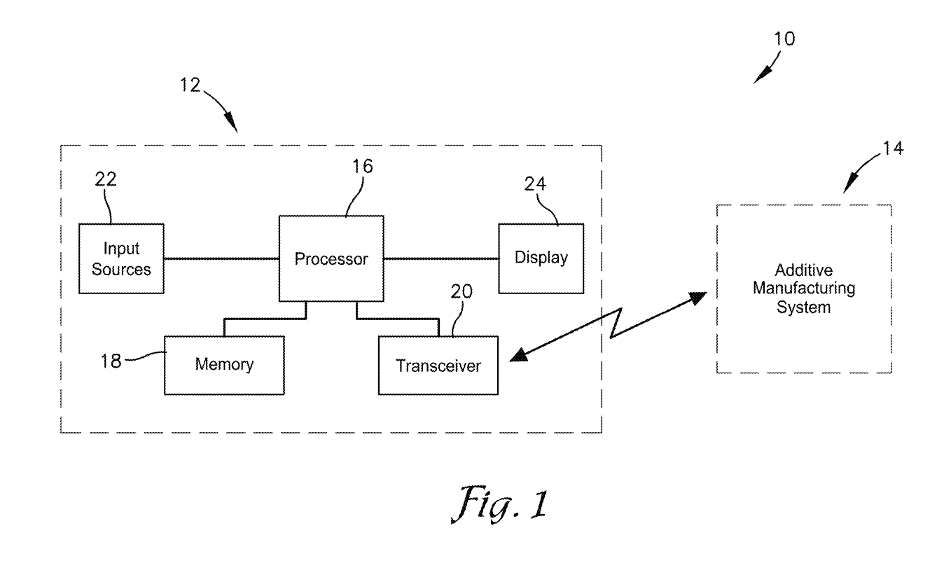

Turning to FIG. 1, a computer modeling and additive manufacturing system 10 constructed in accordance with an embodiment of the present invention is illustrated. The computer modeling and additive manufacturing system 10 broadly comprises a CAD system 12 and an additive manufacturing system 14.

The CAD system 12 may be used for designing and generating a computer model of a part and broadly includes a processor 16, a memory 18, a transceiver 20, a plurality of inputs 22, and a display 24. The CAD system 12 may be integral with or separate from the additive manufacturing system 14.

The processor 16 generates data representative of the part model according to inputs and data received from a user. The processor 16 may include a circuit board, memory, display, inputs, and/or other electronic components such as a transceiver or external connection for communicating with external computers and the like.

The processor 16 may implement aspects of the present invention with one or more computer programs stored in or on computer-readable medium residing on or accessible by the processor. Each computer program preferably comprises an ordered listing of executable instructions for implementing logical functions and generating and manipulating data representative of part models such as volumetric information and metadata in the processor 16. Each computer program can be embodied in any non-transitory computer-readable medium, such as the memory 18 (described below), for use by or in connection with an instruction execution system, apparatus, or device, such as a computer-based system, processor-containing system, or other system that can fetch the instructions from the instruction execution system, apparatus, or device, and execute the instructions.

The memory 18 may be any computer-readable non-transitory medium that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The transceiver 20 may transmit data and instructions between the CAD system 12, the additive manufacturing system 14, and/or other external computing systems. Alternatively, a wired or integrated setup may be used between the CAD system 12 and the additive manufacturing system 14.

The inputs 22 allow a user to create and modify part models and may comprise a keyboard, mouse, trackball, touchscreen, buttons, dials, virtual inputs, and/or a virtual reality simulator. The inputs 22 may also be used to control or instruct the additive manufacturing system 14.

The display 24 may display a two-dimensional or three-dimensional representation of the part models and may also display model data, computer options, and other information via a graphical user interface (GUI). The display 24 may be separate from or integrated with the additive manufacturing system 14.

The additive manufacturing system 14 produces prototypes and parts and may use any conventional additive manufacturing techniques such as vat polymerization, material jetting, binder jetting, material extrusion, powder bed fusion, sheet lamination, and directed energy deposition. It will be understood that the additive manufacturing system 14 may be any type of additive manufacturing or “3D printing” system such as a sintering, laser melting, laser sintering, extruding, fusing, stereolithography, extrusion, light polymerizing, powder bed, wire additive, or laminated object manufacturing system. The additive manufacturing system 14 may also be a hybrid system that combines or replaces additive manufacturing with molding, scaffolding, and/or other subtractive manufacturing or assembly techniques.

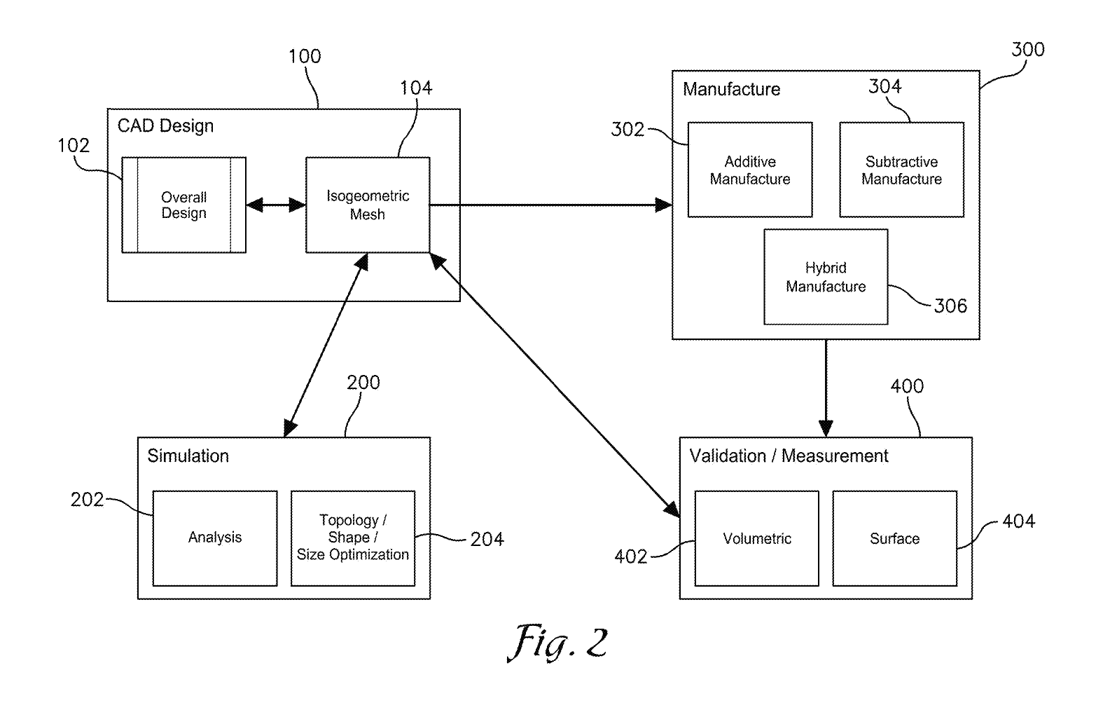

Turning to FIG. 2, use of the computer modeling and additive manufacturing system 10 will now be described in more detail. The computer modeling and additive manufacturing system 10 may operate across four process modules: CAD design 100, simulation 200, manufacturing 300, and validation 400.

CAD design 100 comprises overall part design 102 (part model generation) and, in some embodiments, mesh generation 104. In the overall part design 102, a part model having an isogeometric or isoparameteric definition is generated via the CAD system 12. Isogeometry refers to a set of shape functions being used for both CAD representation and finite elements. The shape functions can vary but may be based on Bezier curves or Bezier surfaces, non-uniform rational B-splines (NURBS), T-Splines, and other curves and surfaces. Isoparametry refers to C⁰ polynomials being used to represent surfaces. In some embodiments, the isogeometric or isoparametric definition may be incorporated within a technical data package in a model-based enterprise.

The part model includes volumetric information, metadata, and/or other data required for additive manufacturing, conventional (e.g., subtractive) manufacturing, and/or hybrid manufacturing processes within the isogeometric or isoparametric definition. For example, the volumetric information may include volumetrically varying information such as material grading based on chemical composition, processing parameters, or any other suitable material grading characteristic. The volumetric information may also include lattice location and deformation information for united cellular lattice structures as described in the '516 publication. The part model, mesh, volumetric information, metadata, and other data may be stored on the memory 18 of the CAD system 12.

In mesh generation 104, the part model is subdivided into a plurality of finite elements so as to form a mesh. The isogeometric or isoparametric definition and the volumetric information, metadata, and/or other data is kept with the mesh such that representations of features of the part do not change.

Simulation 200 comprises finite element analysis (FEA) 202 and topology, shape, and size optimization 204. The FEA 202 may be any conventional finite element analysis including structural, thermal, fluid flow, and electromagnetic analysis. The FEA 202 is performed via the stored volumetric information, metadata, and/or other data within the isogeometric or isoparametric definition of the part model and/or mesh. The part model and/or mesh may then be modified according to results of the FEA 202.

The topology, shape, and size optimization 204 may be incorporated into initial stages of the CAD design 100 and/or implemented once an initial part design has been developed. The topology, shape, and size optimization 204 is performed via the stored volumetric information, metadata, and/or other data within the isogeometric or isoparametric definition of the part model and/or mesh. The part model and/or mesh may then be modified according to results of the topology, shape, and size optimization 204.

Manufacturing 300 includes additive manufacturing 302, subtractive manufacturing 304, hybrid manufacturing 306, and/or other manufacturing processes. Additive manufacturing 302 may include generating slice files directly from the part model and/or mesh. Specifically, the slice files are formed via the stored volumetric information, metadata, and/or other data within the isogeometric or isoparametric definition of the part model and/or mesh. The additive manufacturing 302 may be any additive manufacturing or “3D printing” process such as sintering, laser melting, laser sintering, extruding, fusing, stereolithography, extrusion, light polymerizing, powder or wire processes, or lamination. Other manufacturing techniques may include molding and scaffolding or a combination of the above processes.

Validation and measurement 400 includes volumetric analysis 402 and surface measurements 404. Volumetric analysis 402 may include a computerized tomography (CT) scan, magnetic resonance imaging (MM), neutron imaging, or any other suitable two dimensional or three dimensional scan of the part. Specifically, voxel data from the scan can be compared directly against the volumetric information. For example, actual material grading may be compared directly against isogeometric-defined material grading data. Similarly, surface measurements 404 may include comparing surface measurements directly against isogeometric-defined surface data.

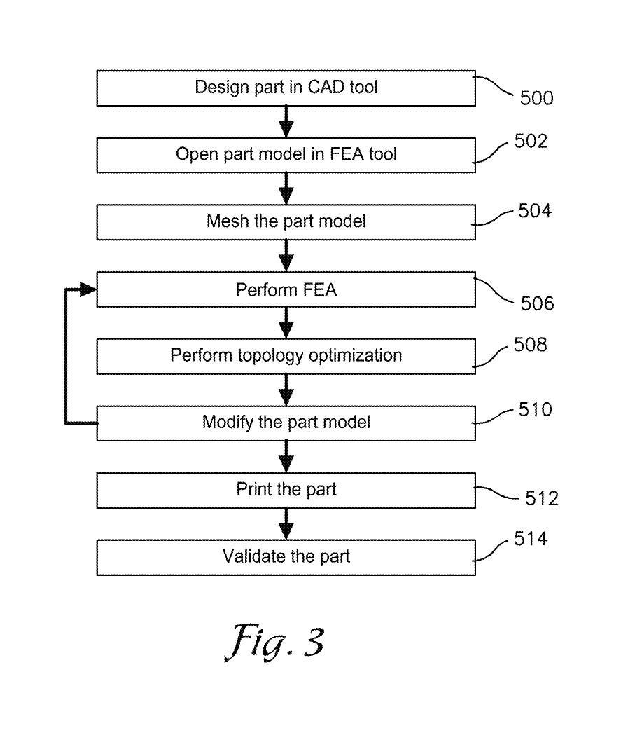

With reference to FIG. 3, an exemplary generation and analysis of a part model and subsequent production and validation of a part according to the part model will now be described. First, the part model may be received or generated in a CAD tool, as shown in block 500. The part model may have an isogeometric or isoparametric definition and includes volumetric information, metadata, and/or other data required for additive manufacturing, conventional (e.g., subtractive) manufacturing, and/or hybrid manufacturing processes.

The part model may then be opened in an FEA tool or any other suitable meshing tool, as shown in block 502. The part model may then be subdivided into a plurality of finite elements so as to form a mesh of the part model, as shown in block 504. The isogeometric or isoparametric definition and the volumetric information, metadata, and other data is kept with the mesh such that representations of features of the part do not change.

Finite element analysis may then be performed on the mesh, as shown in block 506. For example, structural, thermal, fluid flow, and electromagnetic analysis may be performed on the mesh. The FEA is performed via the volumetric information, metadata, and/or other data within the isogeometric or isoparametric definition.

Topology, shape, and/or size optimization may then be performed on the mesh, as shown in block 508. The topology, shape, and/or size optimization is performed via the volumetric information, metadata, and/or other data within the isogeometric or isoparametric definition.

The part model and/or mesh may then be modified based on results of the FEA and the topology, shape, and/or size optimization, as shown in block 510. For example, mesh elements may be removed and other mesh elements may be reshaped to increase a strength to weight ratio, improve heat dissipation, or change an electromagnetic signature or other characteristics of the part. Steps 506-510 may be repeated until suitable part characteristics are achieved.

The part may then be formed via additive manufacturing, conventional (e.g., subtractive) manufacturing, and/or hybrid manufacturing processes, as shown in block 512. For example, the part model or mesh may be divided into slice files via the volumetric information, metadata, and other data within the isogeometric or isoparametric definition. The part may then be printed via a layer-based 3D printer according to the slice files.

The part may then be validated via volumetric analysis and/or surface measurements, as shown in block 514. For example, voxel data from a 3D scan of the part may be compared directly against the volumetric information. Actual material grading of the part may be compared directly against isogeometric or isoparametric-defined material grading data. Surface measurements may be compared directly against isogeometric or isoparametric-defined surface data.

The above-described computer modeling and additive manufacturing system 10 and method provide several advantages over conventional systems. For example, a single CAD representation of the part can be used throughout the CAD design 100, simulation 200, manufacturing 300, and validation 400 process modules. Specifically, volumetric information, metadata, and/or other data associated with the part model are kept with the part model and retain an isogeometric or isoparametric definition throughout these process modules. In this way, part models and meshes are generated, analyzed, and optimized and the associated parts are manufactured and validated directly from the part model or mesh without converting the part model or mesh to a different data format. This is particularly useful for incorporating material grading into the part and validating the material grading. The volumetric information may also include lattice location and deformation information for united cellular lattice structures as described in the '516 publication.

It will be understood that method steps of the above-described invention may be performed in any order, including simultaneously. For example, FEA and topology, shape, and/or size optimization may be performed in a single step or iteration.

The user time and effort and computer cycles required to reconfigure the part model or convert the model to different data formats between process modules are eliminated, which promotes late stage part improvement and modification. User and computer-based errors and inconsistencies introduced from switching between data formats are also eliminated, resulting in more accurate and efficient part model analysis and part production.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A computer-implemented method for improving the production of an object via an additive manufacturing machine, the computer-implemented method comprising performing with an electronic processing element the steps of:
receiving a computer-aided design (CAD) part model having an isogeometric or isoparametric definition;
subdividing the part model into mesh elements so as to form a mesh of the part model, the mesh having the isogeometric or isoparametric definition of the part model;
performing finite element analysis (FEA) on the mesh; and
generating slice files based on the mesh for use in additive manufacturing, the slice files having the isogeometric or isoparametric definition of the part model and mesh such that volumetric information is retained with the part model, mesh, and slice files.

2. The computer-implemented method of claim 1, further comprising the step of modifying the part model according to results of the FEA.

3. The computer-implemented method of claim 1, further comprising the step of assigning graded materials to elements of the mesh such that the part model has a material grading.

4. The computer-implemented method of claim 1, further comprising the step of performing topology optimization on the mesh.

5. The computer-implemented method of claim 1, wherein the isogeometric or isoparametric definition is incorporated within a technical data package in a model based enterprise.

6. The computer-implemented method of claim 1, further comprising the step of instructing an additive manufacturing machine to construct a part based on the slice files.

7. The computer-implemented method of claim 6, further comprising the step of comparing volumetric measurements of the part against the part model or mesh so as to validate the part.

8. The computer-implemented method of claim 7, wherein the step of comparing volumetric measurements includes comparing resultant voxel data directly against isogeometric or isoparametric data of the part model or mesh.

9. The computer-implemented method of claim 7, wherein the step of comparing volumetric measurements includes comparing measured material grading against graded materials assigned to some of the mesh elements.

10. The computer-implemented method of claim 6, further comprising the step of comparing surface measurements of the part against the part model or mesh so as to validate the part.

11. A computer-implemented method for improving the production of an object via an additive manufacturing machine, the computer-implemented method comprising performing with an electronic processing element the steps of:
receiving a computer-aided design (CAD) part model having an isogeometric or isoparametric definition;
subdividing the part model into mesh elements so as to form a mesh of the part model, the mesh having the isogeometric or isoparametric definition of the part model;
performing finite element analysis (FEA) on the mesh;
generating slice files based on the mesh for use in additive manufacturing, the slice files having the isogeometric or isoparametric definition of the part model and mesh such that volumetric information is retained with the part model, mesh, and slice files; and
instructing the additive manufacturing machine to construct a part based on the slice files.

12. The computer-implemented method of claim 11, further comprising the step of modifying the part model according to results of the FEA.

13. The computer-implemented method of claim 11, further comprising the step of assigning graded materials to some of the mesh elements.

14. The computer-implemented method of claim 11, further comprising the step of performing topology optimization on the mesh.

15. The computer-implemented method of claim 11, wherein the isogeometric or isoparametric definition is incorporated within a technical data package in a model based enterprise.

16. The computer-implemented method of claim 11, further comprising the step of comparing volumetric measurements against the part model or mesh so as to validate the part.

17. The computer-implemented method of claim 16, wherein the step of comparing volumetric measurements includes comparing resultant voxel data directly against isogeometric data of the part model or mesh.

18. The computer-implemented method of claim 16, wherein the step of comparing volumetric measurements includes comparing measured material grading against graded materials assigned to some of the mesh elements.

19. The computer-implemented method of claim 11, further comprising the step of comparing surface measurements of the part against the part model or mesh so as to validate the part.

20. A system for creating a part via an additive manufacturing machine, the system comprising:
a computer modeling system comprising:
a processor configured to:
receive a computer-aided design (CAD) part model having an isogeometric or isoparametric definition;
subdivide the part model into mesh elements so as to form a mesh of the part model, the mesh having the isogeometric or isoparametric definition of the part model;
perform finite element analysis on the mesh;
modify at least one of the part model and mesh according to results of the FEA; and
generate slice files based on the mesh for use in additive manufacturing, the slice files having the isogeometric or isoparametric definition of the part model and mesh such that volumetric information is retained with the part model, mesh, and slice files, the volumetric information including material grading data;
a non-transitory computer readable memory configured to store the part model, mesh, and slice files thereon;
a plurality of inputs for receiving inputs from a user; and
a display configured to visually produce the part model and mesh; and
an additive manufacturing system configured to construct the part based on the slice files such that the part has material grading.
